(19) United States
(12) Patent Application Publication
(10) Pub. No.: US 2014/0201089 A1
(43) Pub. Date: Jul. 17, 2014

(54) COMMUNICATIONS SYSTEMS AND METHODS

(71) Applicant: MaxLinear, Inc., Carlsbad, CA (US)

(72) Inventor: Curtis Ling, Carlsbad, CA (US)

(73) Assignee: MaxLinear, Inc., Carlsbad, CA (US)

(21) Appl. No.: 14/157,249

(22) Filed: Jan. 16, 2014

Related U.S. Application Data
(60) Provisional application No. 61/753,160, filed on Jan. 16, 2013.
(60) Provisional application No. 61/754,486, filed on Jan. 18, 2013.

(51) Int. Cl. G06Q 10/00

(52) U.S. Cl. CPC G06Q 10/20
USPC 705/305

(57) ABSTRACT

Various aspects of a method and system for electronics lifetime wear monitoring are provided. Various aspects of a method and system for scheduling various maintenance-related activities based, at least in part, on circuit monitoring are also provided.

### CROSS-REFERENCE TO RELATED APPLICATIONS/INCORPORATION BY REFERENCE

This patent application claims the benefit of U.S. Provisional Application No. 61/753,160, filed Jan. 16, 2013, titled “COMMUNICATIONS SYSTEMS AND METHODS,” the contents of which are hereby incorporated herein by reference in their entirety. This patent application also claims the benefit of U.S. Provisional Application No. 61/754,486, filed Jan. 18, 2013, titled “METHOD AND SYSTEM FOR MOBILE APPLICATION FOR OBTAINING COMMUNICATION SYSTEM DIAGNOSTIC INFORMATION FROM A COMMUNICATION DEVICE VIA AN INTEGRATED CIRCUIT,” the contents of which are hereby incorporated herein by reference in their entirety.

### FEDERALLY SPONSORED RESEARCH OR DEVELOPMENT

[Not Applicable]

### SEQUENCE LISTING

[Not Applicable]

### MICROFICHE/COPYRIGHT REFERENCE

[Not Applicable]

### BACKGROUND

Conventional systems and methods for communications can be overly power hungry, slow, expensive, and inflexible. Further limitations and disadvantages of conventional and traditional approaches will become apparent to one of skill in the art, through comparison of such systems with some aspects of the present invention as set forth in the remainder of the present application with reference to the drawings.

### SUMMARY

Systems and methods for communications, substantially as shown in and/or described in connection with at least one of the figures, as set forth more completely in the claims.

Advantages, aspects and novel features of the present disclosure, as well as details of various implementations thereof, will be more fully understood from the following description and drawings.

### BRIEF DESCRIPTION OF SEVERAL VIEWS OF THE DRAWINGS

FIG. 1 shows a block diagram of an example system that monitors circuit wear and/or schedules maintenance related activities, in accordance with various aspects of the present disclosure.

FIG. 2 shows a block diagram of an example system that monitors circuit wear, in accordance with various aspects of the present disclosure.

FIG. 3 shows a flow diagram of an example method for monitoring circuit wear, in accordance with various aspects of the present disclosure.

FIG. 4 shows a block diagram of an example system that monitors circuit wear and/or schedules maintenance related activities, in accordance with various aspects of the present disclosure.

FIG. 5 shows a flow diagram of an example method for monitoring circuit wear and/or scheduling maintenance related activities, in accordance with various aspects of the present disclosure.

### DETAILED DESCRIPTION OF VARIOUS ASPECTS OF THE DISCLOSURE

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code.

As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the term “exemplary” means serving as a non-limiting example, instance, or illustration.

As utilized herein, the terms “e.g.,” and “for example” set off lists of one or more non-limiting examples, instances, or illustrations.

As utilized herein, circuitry is “operable” to perform a function whenever the circuitry comprises the necessary hardware and code (if any is necessary) to perform the function, regardless of whether performance of the function is disabled, or not enabled, by some user-configurable setting.

As utilized herein, the term “automatically” when preceding a function denotes that the function is performed without manual intervention during performance of the function.

As utilized herein, the term “module” may comprise hardware, a combination of hardware and software, and/or a non-volatile memory comprising instructions that cause a processor to operate in a particular manner. The following discussion is generally separated in modules for illustrative clarity and not necessarily for assigning boundaries between components. For example, a first module may share various hardware and/or software components with a second module. Accordingly, the scope of the present disclosure should not be limited by arbitrary boundaries between various modules unless explicitly stated.

Example embodiments will now be described more fully hereinafter with reference to the accompanying drawings. However, the various aspects of the present disclosure may be embodied in different forms, and thus the provided exemplary embodiments should not be construed as limiting.

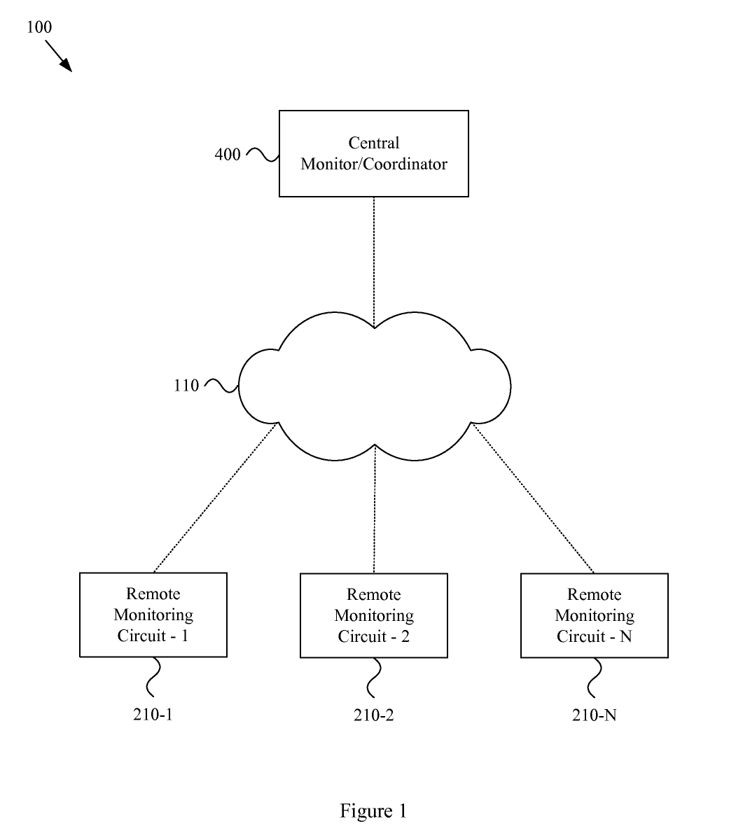

Turing first to FIG. 1, such figure shows a block diagram of an example system 100 that monitors circuit wear and/or schedules maintenance related activities, in accordance with various aspects of the present disclosure. The example system 100 comprises a Central Monitor/Coordinator 400 that is communicatively coupled to Remote Monitoring Circuits 210-1, 210-2, . . . , and 210-N via a communication network 110.

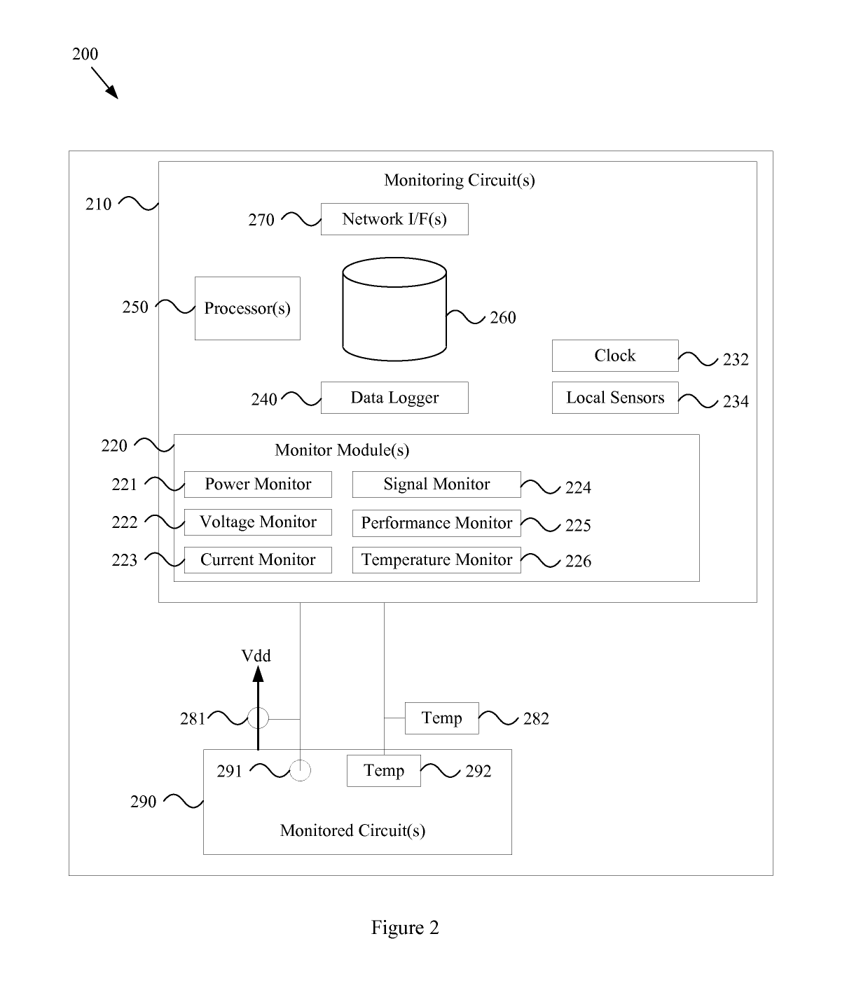

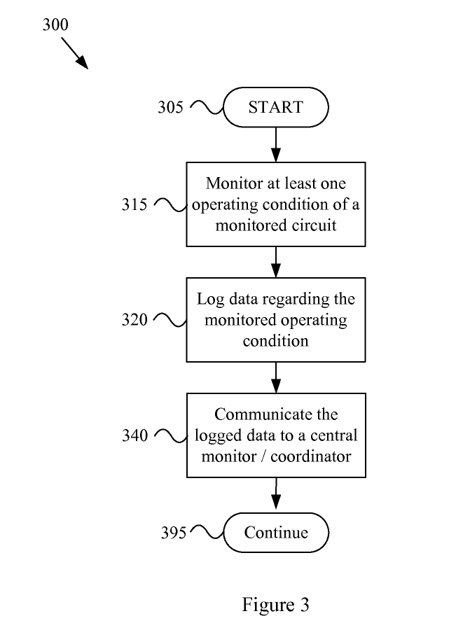

An example of one or all of the Remote Monitoring Circuits 210-1, 210-2, . . . , and 210-N is illustrated in FIG. 2 and an example method 300 for operating the Remote Monitoring Circuits 210-1, 210-2, . . . , and 210-N is illustrated in FIG. 3. Accordingly, the following discussions of FIGS. 2 and 3 apply to the Remote Monitoring Circuits 210-1, 210-2, . . . , and 210-N shown in FIG. 1.

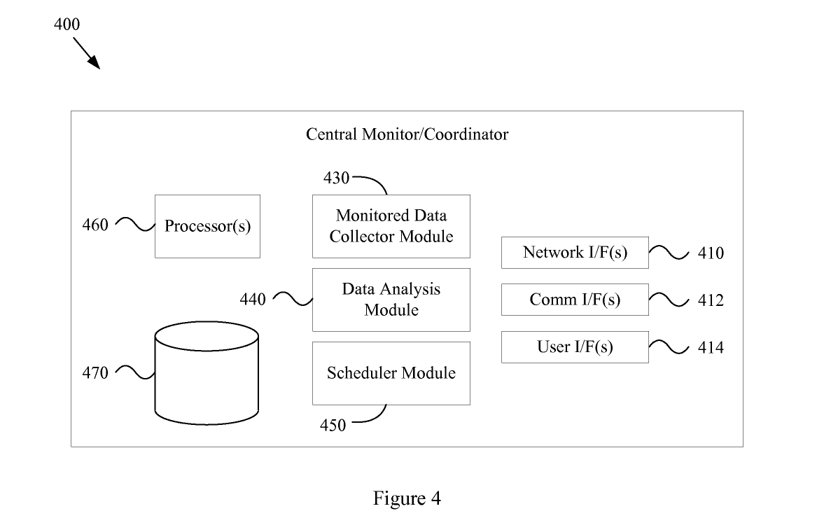

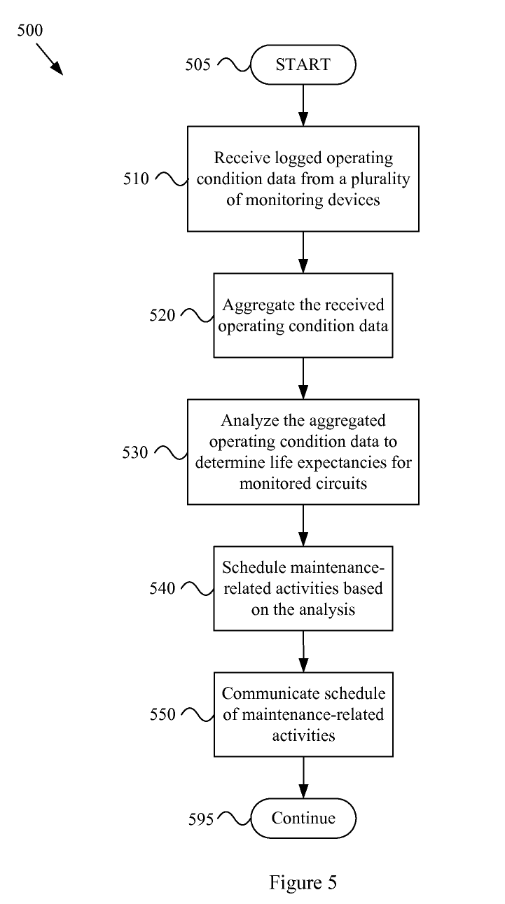

An example of the Central Monitor/Coordinator 400 is illustrated in FIG. 4 and an example method 500 for operating such a Central Monitor/Coordinator 400 is illustrated in FIG. 5. Accordingly, the following discussions of FIGS. 4 and 5 apply to the Central Monitor/Coordinator 400 shown in FIG. 1.

Though relatively more-detailed examples of the components of FIG. 1 are discussed below in FIGS. 2-5, FIG. 1 will now be discussed at a high level. The Central Monitor/Coordinator 400 may, for example, comprise a computer system (e.g., a personal computer, mainframe computer, etc.) that is capable of receiving and analyzing information. Such a computer system may, for example, comprise one or more processors that operate in accordance with software instructions stored in a memory of the computer system. The computer system may, for example, comprise a general-purposes computer programmed to perform the functionality discussed herein by way of non-limiting example and/or may comprise a computing platform that is specifically adapted to perform the functionality discussed herein.

The Central Monitor/Coordinator 400 may, for example, be maintained at a site belonging to an electronics manufacturer and/or provider, an electronics supplier or reseller, an electronics maintenance service, an electronics warehouse, a location of an electronics service provider, etc.

The Central Monitor/Coordinator 400 may, for example, be communicatively coupled to one or more communication networks 100. Such communication network(s) 100 may, for example, comprise one or more wired networks, one or more wireless networks, one or more tethered or non-tethered optical networks, etc. Such communication network(s) 100 may, for example, comprise the Internet, one or more LANs, MANs, WAN, PANs, satellite communication networks, cable television networks, telephony networks, etc.

The Central Monitor/Coordinator 400 may, for example, communicate with one or more Remote Monitoring Circuits 210 (e.g., 210-1, 210-2, . . . , 210-N) via the communication network(s) 100. The Remote Monitoring Circuits 210 may, for example, monitor operating conditions of respective monitored circuits, log information related to such monitoring, and communicate the logged information to a central location (or common location) for processing, for example, to the Central Monitor/Coordinator 400.

A Remote Monitoring Circuit 210 may, for example, be operable to monitor any of a variety of types of information that are known and/or suspected to be indicative of component wear. For example, a Remote Monitoring Circuit 210 may monitor power supply characteristics, for example the characteristics of electrical power provided to and/or drawn by the monitored circuit. The Remote Monitoring Circuit 210 may also, for example, monitor and/or environmental parameters. The Remote Monitoring Circuit 210 may additionally, for example, monitor various electrical signals other then power and environmental-related signals. The Remote Monitoring Circuit 210 may also monitor time, for example a local or remote clock circuit. The Remote Monitoring Circuit 210 may further monitor user I/O activity. More examples of monitored signals and/or characteristics will be provided below.

The Remote Monitoring Circuit 210 may, for example, be operable to maintain a log of the monitored characteristics (e.g., operating conditions). Such a log may, for example, comprise a running total of various monitored events. The maintained log may, for example, also comprise a table of entries (e.g., comprising time or time period and monitored conditions). For example, the log may comprise a list of times or time periods during which particular operating conditions occurred. For example, the log may comprise a list of time periods during which the monitored circuit operated above a particular temperature or with a particular level of drawn current. The maintained log may also comprise a list of all monitoring times and monitored values. The maintained log may, for example, comprise any one or more of the log characteristics discussed above.

The Remote Monitoring Circuit 210 may, for example, be operable to communicate the monitored and/or logged information to another device, for example the Central Monitor/Coordinator 400. The Remote Monitoring Circuit 210 may, for example, be operable to communicate the monitored and/or logged information in response to any of a variety of causes and/or conditions. For example, the Remote Monitoring Circuit 210 may be operable to communicate the logged information in response to an inquiry (or poll) message received and/or autonomously, in response to the logged information reaching a certain volume, on a timed basis, in response to one or more monitored parameters reaching an alarm threshold, in response to a user command, when it is determined that the Network 110 is in a relatively low-utilization state, etc.

The Central Monitor/Coordinator 400 may, for example, be operable to receive the logged information (e.g., operating condition information) from the Remote Monitoring Circuits 210 via the Communication Network 110. The Central Monitor/Coordinator 400 may receive the logged information in any of a variety of manners. For example, the Central Monitor/Coordinator 400 may receive the logged information as one or more respective solicited messages in response to requests sent to the Monitoring Circuits 210 for the logged information. Also for example, the Central Monitor/Coordinator 400 may receive the logged information as unsolicited messages from Monitoring Circuits 210 (e.g., sent autonomously from the Monitoring Circuits 210).

After the Central Monitor/Coordinator 400 receives the monitored and/or logged information from the one or more Remote Monitoring Circuits 210, the Central Monitor/Coordinator 400 may perform any of a variety of activities. For example, the Central Monitor/Coordinator 400 may be operable to aggregate the received information, for example in a database. The Central Monitor/Coordinator 400 may, for example, develop a circuit life expectancy model and/or utilized such a model to determine an expected life expectancy for a monitored circuit (or associated device). The Central Monitor/Coordinator 400 may, for example, analyze the received information, for example to ascertain circuit wear and/or to determine a life expectancy (e.g., either absolute or relative to other circuits for maintenance prioritization). For example, the Central Monitor/Coordinator 400 may total information received for a particular monitored circuit. Such totals may then be utilized to predict life expectancy for a circuit, for example comparing the total to one or more thresholds associated with a circuit nearing end-of-life. In another example scenario, the Central Monitor/Coordinator 400 may keep track of peak values for one or more monitored operating conditions. Such peak operating conditions may then be utilized to predict life expectancy for a circuit, for example comparing the peak values to one or more thresholds associated with a circuit nearing end-of-life. In another example scenario, the Central Monitor/Coordinator 400 may average received operating condition information. Such averages may then be utilized to predict life expectancy for a circuit, for example comparing the total to one or more thresholds associated with a circuit nearing end-of-life. In yet another example scenario, the Central Monitor/Coordinator 400 may calculate statistical variance and/or standard deviation of received operating condition information. Such information may, for example, be utilized to determine whether a monitored circuit (or device including such circuit) has failed and/or is beginning to fail.

In general, the Central Monitor/Coordinator 400 may analyze received information concerning monitored circuit operating conditions to determine life expectancies of remote circuits. Additionally, the Central Monitor/Coordinator 400 may also consider information other than the received information concerning monitored circuit operating conditions. Examples of such information comprise: geographical location, origin of monitored circuitry, type of device or appliance into which a monitored circuit is installed, device model, etc.

As discussed above, the analysis may comprise determining an estimated life expectancy for a circuit or component thereof. Determined life expectancies may, for example, be utilized to coordinate maintenance activities for a monitored circuit or device incorporating the circuit. Such scheduling may, for example, comprise scheduling service activities, scheduling component and/or unit ordering, scheduling shipping activities, scheduling production, etc. The scheduling may then, for example, be communicated to various interested parties, for example field technicians and/or field maintenance organizations, distribution enterprises, warehousing enterprises, production enterprises, operators of the Central Monitor/Coordinator 400, etc. Such communicating may, for example, be performed over a communication network, using a user interface, etc.

As mentioned above, the discussion of FIGS. 2-5 will provide many more detailed examples of the operation introduced above.

Turning next to FIG. 2, such figure shows a block diagram of an example system 200 that monitors circuit wear, in accordance with various aspects of the present disclosure. The example system 200 comprises a Monitoring Circuit 210 and one or more Monitored Circuit(s) 290. The example system 200 also includes an example current sensor 281 and temperature sensor 282 that might not be on-board the Monitored Circuit 290. The Monitoring Circuit 210 and the Monitored Circuit(s) 290 are illustrated as separate circuits, but in practice need not be separate. For example, the Monitoring Circuit 210 and Monitored Circuit 290 may be implemented in a distinct circuit (e.g., onboard separate integrated circuit packages), in separate die onboard a same integrated circuit package, in distinct modules of a single integrated circuit die, and/or generally indistinctively integrated into a single integrated circuit die.

The Monitoring Circuit 210 may, for example, share any or all characteristics with the Monitoring Circuits 210-1, 210-2, . . . , 210-N illustrated in FIG. 1 and discussed previously. The Monitoring Circuit 210 may comprise any of a variety of components. For example, the Monitoring Circuit 210 may comprise one or more modules operable to monitor operating conditions of one or more monitored circuits (e.g., a Power Monitor module 221, a Voltage Monitor module 222, a Current Monitor module 223, a Signal Monitor module 224, a Performance Monitor module 225 (e.g., for monitoring circuit speed, accuracy, noise, etc.), a Temperature Monitor module 226, etc.). The Monitoring Circuit 210 may also comprise various Local Sensors 234 (e.g., heat sensors, humidity sensors, shock sensors, vibration sensors, etc.) and a Clock 232. The Monitoring Circuit 210 may comprise a Data Logger module 240 that is operable to log monitored data, and one or more Network Interface modules 270 for communicating over one or more respective communication networks. The Monitoring Circuit 210 may, for example, comprise a memory 260 (e.g., non-volatile memory or volatile memory) that may for example store logged monitored information, software instructions, etc. The Monitoring Circuit 210 may also have a Processor 250, which may for example, comprise an application specific integrated circuit (“ASIC”) and/or a general purpose processor. The Processor 250 may, for example, be operable to perform the functionality of any or all modules of the Monitoring Circuit 210 discussed herein.

The Monitored Circuit 290 may, for example, comprise characteristics of any electrical circuit to be monitored. For example and without limitation, the Monitored Circuit 290 may comprise characteristics of circuit in a cable and/or DOCSIS system (e.g., circuitry of cable modem termination systems (CMTSs), circuitry in fiber nodes, circuitry in remote PHYs, circuitry in customer premise equipment (e.g., cable modems), etc. Also for example, the Monitored Circuit 290 may comprise characteristics of circuitry in a satellite communication system (e.g., direct broadcast satellite (DBS)) system circuitry, circuitry of low noise block downconverters, circuitry of band/channel stacking switches, circuitry of customer premises equipment (CPE) for example set top boxes, mobile communication devices, etc.). Additionally for example, the Monitored Circuit 290 may comprise characteristics of circuitry in a terrestrial wireless communication system (e.g., circuitry of base stations or access points, radio network controllers, wireless routers, handsets, mobile devices, femtocell circuitry, etc.). Further for example, the Monitored Circuit 290 may comprise characteristics of circuitry in a general network system (e.g., circuitry in servers, routers, switches, switch fabric, fiber channel switches, etc.). Also for example, the Monitored Circuit 290 may comprise characteristics of circuitry in general computing systems (e.g., circuitry of hard disk drives, solid-state drives, CPUs, bus controllers, user I/O, network interface circuitry, etc.). The Monitored Circuit 290 may, for example, generally comprise characteristics of any identifiable and monitorable device or circuit in the Internet-of-Things (IoT).

As mentioned above, the Monitored Circuit 290 may be implemented in a circuit that is distinct from the Monitoring Circuit 210 (e.g., onboard a different integrated circuit package than the Monitoring Circuit 210), on a die that is distinct from the Monitoring Circuit 210 (e.g., onboard a different die than the Monitoring Circuit 210, for example contained in a same integrated circuit package as the Monitoring Circuit 210), in a module of an integrated circuit die that is distinct from the Monitoring Circuit 210 (e.g., onboard a different module than the Monitoring Circuit 210, for example contained in a same semiconductor die as the Monitoring Circuit 210), and/or generally indistinctively integrated into a single circuit (e.g., an integrated circuit die).

Also for example, the Monitored Circuit(s) 290 may comprise one or more separately monitored circuits. For example, in an example implementation, the Monitored Circuit(s) 290 may comprise a plurality of distinct circuits, which may be operating together (e.g., in a partnership and/or supporting manner). In such an implementation, the Monitored Circuit(s) 290 may comprise a plurality of distinct circuits that are monitored separately and/or in aggregate.

Additionally, for example, the Monitored Circuit(s) 290 may comprise electrical and/or electrical-mechanical circuitry. For example, the Monitored Circuit(s) 290 may comprise any of a variety of types of electric machines and/or parts coupled thereto (e.g., linear and/or rotary motors, electromechanical actuators, etc.), Microelectromechanical System (MEMS) devices, environmental sensing circuits, transducers, etc. Such monitored electromechanical devices may themselves be integrated into larger system (e.g., vehicles, appliances, etc.), which may in turn also be monitored.

The following discussion will now present operational aspects of the above-mentioned circuits and/or modules by way of non-limiting example.

The Monitoring Circuit 210 comprises one or more Monitor Modules 220 that are operable to monitor one or more operating conditions of the Monitored Circuit(s) 290. Example Monitor Module(s) 220 may comprise a Power Monitor nodule 221, a Voltage Monitor module 222, a Current Monitor Module 223, a Signal Monitor module 224, a Performance Monitor module 225, and a Temperature Monitor module 226, etc. The sensors utilized for any or all of the monitoring discussed herein may be on-board the Monitoring Circuit 210, on-board the Monitored Circuit 290, in close proximity to such circuits, within or on a housing containing such circuits, etc.

The Monitor Modules 220 may, for example, be operable to monitor power supply characteristics (e.g., using a Power Monitor module 221, a Voltage Monitor module 222, a Current Monitor module 223, etc.), for example the characteristics of electrical power provided to and/or drawn by the monitored circuit. Examples of such power supply characteristics may comprise electrical current, electrical voltage, electrical power, power supply interruptions, power supply surges, etc. For example, the Current Monitor module 223 may interface with a current sensor 281 that monitors electrical current drawn by the Monitored Circuit 290.

The Monitor Modules 220 may, for example, monitor power signals (e.g., voltage, current, etc.) internal to the Monitored Circuit 290. For example, the Current Monitor module 223 may interface with a current sensor 291 that is onboard the Monitored Circuit 290 (e.g., incorporated into a package housing the Monitored Circuit 290 in integrated circuit form).

The Monitor Modules 220 may, for example, be operable to monitor and/or environmental parameters (e.g., using a Temperature Monitor module 226, a humidity sensing module, an air quality sensor, vibration sensor, shock sensor, g-force sensor, etc.), for example temperature (circuit, ambient, etc.) values and/or temperature cycling, humidity, salt exposure and/or exposure to any other known corrosive elements, etc. In an example scenario, the Temperature Monitor module 226 may interface with a Local Sensor 234 that monitors temperature, may interface with a Temperature sensor 282 that is positioned proximate the Monitored Circuit 290, may interface with a Temperature sensor 292 that is on-board the Monitored Circuit 290 (e.g., incorporated into a package housing the Monitored Circuit 290 in integrated circuit form), etc.

The Monitor Modules 220 may, for example, be operable to monitor various electrical signals other then power and environmental-related signals (e.g., using a Signal Monitor module 224, Performance Monitor module 225, etc.). For example, the Monitor Modules 220 may monitor enable lines, data lines, address lines, clock lines, interrupt lines, read/write control lines, bus lines, network communication lines, power on/off signal lines, reset and/or reboot signals, etc.

The Monitor Modules 220 may also monitor time, for example a local (e.g., Clock Module 232) or remote clock circuit. For example, in such an example scenario, the Monitor Modules 220 may track absolute time and/or time span related to other monitored characteristics. For example, the Temperature Monitor module 226 may track an amount of time at which operating temperature of the Monitored Circuit 290 operates at or above a particular temperature. The Monitor Modules 220 may further monitor user I/O, communications between the Monitored Circuit 290 and other circuitry, etc.

In general, the Monitor Module 220 may be operable to monitor any of a variety of operating conditions of a monitored circuit. Accordingly, the scope of various aspects of the disclosure should not be limited by characteristics of any particular manner of performing such monitoring nor of any particular operating condition monitored, unless explicitly stated.

The Data Logger module 240 may, for example, be operable to maintain a log of the monitored operating conditions. The Data Logger module 240 may, for example, create and maintain such a log in the memory 260. The log may comprise any of a variety types of information concerning monitored operating conditions of the Monitored Circuit 290.

For example, the maintained log may comprise a running total of various monitored events (e.g., number of times powered up and/or turned on/off (e.g., as indicated by control signals, power consumption, current amount, operating temperature, etc.), amount of time running normally or performing the operations for which the monitored circuit was designed, amount of time operating below and/or above a particular temperature, amount of time exposed to harsh environmental conditions (e.g., freezing temperatures, extreme heat, excessive vibration, physical shock, etc.), amount of time drawing a particular level of current or power, etc.

The maintained log may, for example, also comprise a table of entries (e.g., comprising time or time period and monitored conditions). For example, the log may comprise a list of times or time periods during which particular operating conditions occurred. For example, the log may comprise a list of time periods during which the monitored circuit operated above a particular temperature or with a particular level of drawn current. In an example manner of operating, the Data Logger 240 may be operable to assess the importance of a monitored operating condition and, based on various criteria, decide whether the monitored characteristic should be logged. For example, if a monitored temperature is below a minimum threshold, the Data Logger 240 may determine that the monitored temperature is not important enough to log (e.g., thereby strategically saving memory space for only the relatively important monitored conditions). In an example implementation, for example in an Internet-of-Things (IoT) based implementation, monitored data and/or the analysis thereof discussed below may be linked to virtual objects representative of the real devices or circuits being monitored.

The maintained log may also comprise a list of all monitoring times and monitored values. In other words, rather than intelligently determining whether a particular one or more monitored operating conditions are worthy of being logged, the Monitoring Circuit 210 might log all monitoring activity, for example leaving it up to the Central Monitor/Coordinator 400 to ascertain the importance of all monitored conditions.

In general, the Data Logger 240 is operable to maintain a log of monitored circuit operating conditions. Accordingly, the scope of various aspects of this disclosure should not be limited by characteristics of any particular type of log, of any particular type of information maintained in a log, nor or any particular manner of maintaining a log, unless explicitly stated.

Note that various other aspects of the Monitoring Circuit 210 may comprise forwarding monitored operating condition information (e.g., to a Central Monitor/Coordinator 400) in real-time as such information is obtain, as opposed to maintaining a local log of such information. In such a scenario, a Central Monitor/Coordinator 400 may, for example, maintain a single log at a central location rather than having distributed logs.

The Monitoring Circuit 210 may, for example, be operable to communicate the monitored and/or logged information to another device, for example the Central Monitor/Coordinator 400 discussed elsewhere herein. The Remote Monitoring Circuit 210 (e.g., the Processor 250) may, for example, be operable to utilize one or more Network Interface modules 270 to communicate the monitored and/or logged information in response to any of a variety of causes and/or conditions.

For example, the Monitoring Circuit 210 may be operable to communicate the logged information in response to an inquiry (or poll) message received (e.g., from the Central Monitor/Coordinator 400). For example, the Monitoring Circuit 210 may be operable to autonomously determine to communicate the logged information in response to any of a variety of conditions identified by the Monitoring Circuit 210. Also for example, the Monitoring Circuit 210 may be operable to communicate the logged information in response to the logged information reaching a certain volume, for example a particular amount of memory (e.g., the Memory 260) having been consumed or remaining. The Monitoring Circuit 210 may, for example, communicate the logged information on a timed basis (e.g., periodically, for example, hourly, nightly, weekly, monthly, etc.). Additionally for example, the Monitoring Circuit 210 may be operable to communicate the logged information in response to one or more monitored parameters reaching an alarm threshold. Still further for example, the Monitoring Circuit 210 may be operable to communicate the logged information in response to a user command (e.g., made by a field technician or user that is not satisfied with the performance of an electronic device). Yet further for example, the Monitoring Circuit 210 may be operable to communicate the logged information when it is determined that the Network 110 is in a relatively low-utilization state, for example substantially below average utilization. In general, the Monitoring Circuit 210 may be operable to communicate the monitored and/or logged information in response to any of a variety of causes and/or conditions. Accordingly, the scope of the present disclosure should not be limited by characteristics of any particular cause and/or condition unless explicitly stated.

In general, the Monitoring Circuit 210 may be operable to communicate the monitored and/or logged information to another device. Accordingly, the scope of various aspects of the disclosure should not be limited by characteristics of any particular manner of performing such communicating unless explicitly stated.

The previous discussion presented various characteristics of a Monitoring Circuit 210 and Monitored Circuit 290 by way of non-limiting example. The discussion will now move to presenting various functional aspects that may be performed by a circuit (e.g., a Monitoring Circuit 210) in a flow diagram form.

FIG. 3 shows a flow diagram of an example method 300 for monitoring circuit wear, in accordance with various aspects of the present disclosure. The method 300 may, for example, share any or all functional aspects discussed with regard to the system 200 of FIG. 2 and the system 100 of FIG. 1, and discussed previously. The method 300 may, for example, be executed in whole or in part by a monitoring circuit, for example, the Monitoring Circuit 210 illustrated in FIG. 2 and discussed previously.

The example method 300 may start at step 305. The method 300 may begin executing in response to any of a variety of causes or conditions (e.g., powering up, resetting, receiving a poll signal, receiving a timer signal, user command, failure detection, etc.). Accordingly, the scope of various aspects of this disclosure should not be limited by characteristics of any particular cause or condition unless explicitly stated.

The example method 300 may, at step 315, comprise monitoring operating conditions of a monitored circuit. The previous discussions of FIG. 2 (e.g., with regard to the Monitoring Circuit 210 and/or Monitor Modules 222) and FIG. 1 (e.g., with regard to the Remote Monitoring Circuits 210-1, 210-2, . . . , and 210-N) presented many non-limiting examples of such monitoring. Accordingly step 315 may share any or all characteristics with such previously discussed monitoring.

For example, step 315 may comprise monitoring any of a variety of types of information that are known and/or suspected to be indicative of component wear. For example, step 315 may comprise monitoring power supply characteristics, for example the characteristics of electrical power provided to and/or drawn by the monitored circuit. Step 315 may also for example comprise monitoring monitor and/or environmental parameters. Step 315 may further for example comprise monitoring various electrical signals other then power and environmental-related signals. Step 315 may additionally for example comprise monitoring time. Step 315 may also for example comprise monitoring user I/O activity. More examples of monitored signals and/or characteristics will be provided below.

In general, step 315 may comprise monitoring operating conditions of a monitored circuit. Accordingly, the scope of various aspects of step 315 should not be limited by characteristics of any particular monitored condition, of any particular manner of monitoring, etc., unless explicitly stated.

The example method 300 may, at step 320, comprise logging data corresponding to the monitored operation conditions (e.g., as monitored at step 315). The previous discussions of FIG. 2 (e.g., with regard to the Monitoring Circuit 210 and/or Data Logger 240) and FIG. 1 (e.g., with regard to the Remote Monitoring Circuits 210-1, 210-2, . . . , and 210-N) presented many non-limiting examples of such logging. Accordingly step 320 may share any or all characteristics with such previously discussed logging.

For example, step 320 may comprise maintaining a log of the monitored characteristics (e.g., operating conditions). Such a log may, for example, comprise a running total of various monitored events. The maintained log may, for example, also comprise a table of entries (e.g., comprising time or time period and monitored conditions). For example, the log may comprise a list of times or time periods during which particular operating conditions occurred. For example, the log may comprise a list of time periods during which the monitored circuit operated above a particular temperature or with a particular level of drawn current. The maintained log may also comprise a list of all monitoring times and monitored values. The maintained log may, for example, comprise any one or more of the log characteristics discussed above.

In general, step 320 may comprise maintaining a log of the monitored characteristics. Accordingly, the scope of various aspects of step 320 should not be limited by characteristics of any particular type of log, of any particular contents of a log, of any particular manner of logging information, etc., unless explicitly claimed.

The example method 300 may, at step 330, comprise communicating the logged data (e.g., as logged at step 320) or a portion thereof, for example to a central or common computing device via a communication network. The previous discussions of FIG. 2 (e.g., with regard to the Monitoring Circuit 210, Processor 250, and/or Network Interface 270) and FIG. 1 (e.g., with regard to the Remote Monitoring Circuits 210-1, 210-2, . . . , and 210-N and/or the Communication Network 110) presented many non-limiting examples of such logging. Accordingly step 330 may share any or all characteristics with such previously discussed logging.

Step 340 may, for example comprise communicating the monitored and/or logged information to another device (e.g., a central computer or Central Monitor/Coordinator 400). Step 340 may, for example, comprise communicating the monitored and/or logged information in response to any of a variety of causes and/or conditions. For example, step 340 may comprise communicating the logged information in response to an inquiry (or poll) message received and/or autonomously, in response to the logged information reaching a certain volume, on a timed basis, in response to one or more monitored parameters reaching an alarm threshold, in response to a user command, when it is determined that the a communication network is in a relatively low-utilization state, etc. Step 340 may, for example, comprise communicating the monitored and/or logged information over any of a variety of types of communication networks utilizing any of a variety of types of communication protocols.

In general, step 340 may comprise communicating the logged data (e.g., as logged at step 320) or a portion thereof. Accordingly, the scope of various aspects of step 340 should not be limited by characteristics of any particular type of information being communicated, of any particular type of communication network, of any particular type of communication protocol, of any particular type of initiating cause or conditions, etc., unless explicitly stated.

The example method 300 may, at step 395, perform continued processing. Step 395 may comprise performing any of a variety of types of continued processing. For example, step 395 may comprise directing execution flow to any other step of the method 300. Step 395 may also comprise directing execution flow to any step of the example method 500 illustrated in FIG. 5 and discussed below. Step 395 may, for example, comprise continuing to monitoring, log, and/or communicate operating condition information for one or more monitored circuits. The scope of various aspects of this disclosure should not be limited by characteristics of any particular type of continued processing.

Turning next to FIG. 4, such figure shows a block diagram of an example system 400 (e.g., a Central Monitor/Coordinator) that monitors circuit wear and/or schedules maintenance related activities, in accordance with various aspects of the present disclosure. The example system 400 comprises one or more Network Interface modules 410, Communication Interface modules 412, and/or User Interface modules 414. The example system 400 may also for example comprise a Monitored Data Collector Module 430, Data Analysis Module 440, and/or a Scheduler Module 450. The example system 400 may, for example, comprise a memory 470 that may for example store received logged monitored information and/or analysis results thereof, software instructions, component life expectancy models, formed servicing schedules, formed ordering schedules, formed production schedules, etc. The example system 400 may also have a Processor 460, which may for example, comprise an application specific integrated circuit (“ASIC”) and/or a general purpose processor. The Processor 460 may, for example, be operable to perform the functionality of any or all modules of the system 400 discussed herein.

The Central Monitor/Coordinator 400 may, for example, share any or all characteristics with the Central Monitor/Coordinator 400 illustrated in FIG. 1 and discussed previously.

The following discussion will now present operational aspects of the above-mentioned circuits and/or modules by way of non-limiting example.

The Central Monitor/Coordinator 400 may, for example, be operable to receive monitored and/or logged information (e.g., operating condition information) from remote monitoring circuits (e.g., the Remote Monitoring Circuits 210 of FIG. 1 and/or Monitoring Circuit 210 of FIG. 2) via at least one communication network (e.g., the Communication Network 110 of FIG. 1. The Central Monitor/Coordinator 400 may, for example, utilize the Network Interface module(s) 410 to perform such receiving.

For example, the Central Monitor/Coordinator 400 may receive the logged information in any of a variety of manners. For example, the Central Monitor/Coordinator 400 may receive the logged information as one or more respective solicited messages in response to requests sent to the monitoring circuits for the logged information. Such requesting messages may, for example be communicated to monitoring circuits (e.g., the Monitoring Circuit 210) using the Network Interface module(s) 410. Also for example, the Central Monitor/Coordinator 400 may receive the logged information as unsolicited messages from monitoring circuits (e.g., from the Monitoring Circuits 210), where such unsolicited message are sent autonomously from the monitoring circuits.

After the Central Monitor/Coordinator 400 receives the monitored and/or logged information from the one or more monitoring circuits, the Central Monitor/Coordinator 400 may perform any of a variety of activities. For example, the Central Monitor/Coordinator 400 may be operable to aggregate the received information. For example, a Monitored Data Collector Module 430 may be operable to store all or a portion of the received information in a database in the Memory 470. In such a scenario, the Central Monitor/Coordinator 400 (e.g., the Data Analysis Module 440) may be operable to analyze the received information at the group level and/or at the level of individual monitored circuits. The Monitored Data Collector Module 430 may, for example, store some or all of the received information in a database in the Memory 470 that can be searched by circuit ID, circuit type, etc. The database may also, for example, be searched by monitored operating condition.

As will be discussed below, a circuit life expectancy model may be developed and/or utilized to determine an expected life expectancy for a monitored circuit (or associated device). In such a scenario, the Data Analysis Module 440 may process the aggregated information to adjust the model in response to actual monitored results. For example, if a present model predicts that a life expectancy for a monitored circuit is a first amount of time based on one or more particular monitored operating conditions, but actual results aggregated over time indicate that a second amount of time is a more accurate prediction, then the Data Analysis Module 440 may adjust the life expectancy model to more accurately predict life expectancy.

The Data Analysis Module 440 may, for example, analyze the received information, for example to ascertain circuit wear and/or to determine a life expectancy (e.g., either absolute or relative to other circuits for maintenance prioritization). For example, the Data Analysis Module 440 may total information received for a particular monitored circuit. In an example scenario in which the monitored circuit operating conditions comprise total operating time for a monitored circuit, received monitored information regarding recent operating time for the monitored circuit may be added to operating time information previously received for the monitored circuit (e.g., to create a running total). Such totals may, for example, be maintained for any or all operating conditions discussed herein (e.g., total time above a particular temperature, total amount of current drawn, total number of times power cycled, total power consumed, etc.). Such totals may then, for example, be compared to one or more respective thresholds that for example may correspond to one or more respective life expectancy values. For example, in a scenario in which operating time is a monitored operating condition, total operating time may be compared to one or more threshold values to determine an estimated remaining life for the monitored circuit.

In another example scenario, the Data Analysis Module 440 may keep track of peak values for one or more monitored operating conditions. For example, peak operating temperature may be tracked. Also for example, peak current drawn, peak power consumption, lowest temperature, peak temperature swing, peak mechanical impact, and so on, may be tracked. In such an example, scenario, peak or extreme operating conditions that impact life expectancy for the monitored circuit (or associated device) may be tracked and utilized to predict circuit life expectancy. Such peak values may then, for example, be compared to one or more respective thresholds that for example may correspond to one or more respective life expectancy values. For example, in a scenario in which peak power and/or current drawn is a monitored operating condition, peak power may be compared to one or more threshold values to determine an estimated remaining life for the monitored circuit. In an example scenario, a peak current or power draw of a particular level may correlate to a respective estimated life remaining for the monitored circuit. In another example scenario, a peak operating temperature may correlate to a respective estimated life remaining for the monitored circuit and/or device that includes the monitored circuit.

In another example scenario, the Data Analysis Module 440 may average received operating condition information. For example, an average monitored circuit or device utilization per time period may be calculated. Also for example, an average current drawn for a circuit during normal operation may be calculated. Additionally for example, an average power consumed for a circuit may be calculated. As will be discussed below, such averaging information may be utilized to determine whether one more monitored operating conditions for a circuit are on-average significantly above or below where they should be for a healthy circuit, a condition that might be indicative of a circuit failing or beginning to fail. For example, as a circuit wears and approaches end-of-life, various average operating conditions may change (e.g., operating at a higher-than-expected current or power draw, operating at a higher-than-expected temperature, etc.). Also for example, as a circuit wears and approaches end-of-life, the circuit or a device incorporating the circuit may be reset or rebooted or power-cycled a higher-than-expected average number of times per time period. Additionally for example, as a circuit wears and approaches end-of-life, the circuit might runner at a higher temperature or higher average temperature. In such cases, temperature or average temperature, power drawn or average power draw, number of resets or average number of resets, etc., may be analyzed to determine a life expectancy.

In yet another example scenario, the Data Analysis Module 440 may calculate statistical variance and/or standard deviation of received operating condition information. Such information may, for example, be utilized to determine whether a monitored circuit (or device including such circuit) has failed and/or is beginning to fail. For example, measures of statistical variability may be combined with statistical average to create a control chart for a monitored circuit (e.g., for a particular monitored circuit and/or for a particular type of monitored circuit). Information received from a monitoring circuit may then be analyzed in light of the control chart (e.g., by analyzing single values, short-term averages, trends, etc.) to determine whether a monitored operating condition is merely a statistical anomaly or statistically significant, for example likely a sign of a present or imminent circuit failure. In an example scenario, temperature of a monitored circuit may be monitored and processed. In such a scenario, if one or more monitored temperatures (e.g., individual or averaged values, trends, etc.) behave in a manner that is different than expected and in a manner that is statistically highly likely to be more than a mere random occurrence, a determination may be made that the monitored circuit is approaching end-of-life. Statistical degrees of confidence may also be assigned to such an end-of-life prediction, which may be utilized to prioritize schedule maintenance-related activities as discussed below.

Some of the above-mentioned analysis techniques involved comparing monitored values, averages thereof, etc., to threshold values or levels. The threshold values may be determined in any of a variety of manners. For example, threshold values may be determined by theoretical analysis. Also for example, threshold values may be determined experimentally at design or production time (e.g., by stress-testing circuitry, testing circuitry under extreme operating conditions, testing circuitry at accelerated use levels, etc.). Additionally for example, threshold values may be determined in real-time, for example as a database of monitored operating conditions having circuit failures associated therewith is built and analyzed over time, as a statistical control value based on operating condition variability, etc. In such a scenario, a life expectancy model may be modified as information regarding monitored circuit operating conditions and circuit failures accrues over time.

The Data Analysis Module 440 may, for example, utilize any one or more of the analysis techniques discussed above. In an example scenario, the Data Analysis Module 440 may rely on the analysis of a plurality of factors, at least some of which may be related to monitored operating conditions, to predict remaining circuit life. In an example scenario involving the analysis of a plurality of factors (e.g., a plurality of monitored circuit operating conditions) in the life-expectancy analysis, some conditions (e.g., operating time) may be given a higher weighting than other conditions (e.g., current draw), but the plurality of conditions may still be considered. In another example scenario, a plurality of conditions may be considered with equal weighting.

In general, the Data Analysis Module 440 may analyze received information concerning monitored circuit operating conditions to determine life expectancies of remote circuits. Additionally, the Data Analysis Module 440 may also consider information other than the received information concerning monitored circuit operating conditions when determine life expectancy. Examples of such information comprise: geographical location (e.g., It might be known that monitored circuits or devices including the monitored circuits may have shorter or longer life expectancies depending on the geographic location of their end use, for example in a hot weather or cold weather environment, in an environment with a relatively high content of salt of other corrosive agents in the air, etc.), origin of monitored circuitry (e.g., It might be known that circuits produced and/or stored at a particular geographic location have shorter or longer life expectancies than others.), type of device or appliance into which a monitored circuit is installed (e.g., It might be known that circuits wear faster when incorporated into a particular type of device or device model than when incorporated into another particular type of device or device model.), etc.

As discussed above, the analysis may comprise determining an estimated life expectancy for a circuit or component thereof. Determined life expectancies may, for example, be utilized to coordinate maintenance activities for a monitored circuit or device incorporating the circuit. The Central Monitor/Coordinator 400 (e.g., the Scheduler Module 450) may be operable to process the life expectancy information to schedule any of a variety of maintenance-related activities, many non-limiting examples of such scheduling will now be provided.

Such scheduling may, for example, comprise scheduling service activities (e.g., field test activities, remote automated or semi-automated testing, device replacement, etc.) based at least in part on the determined life expectancies. For example, the Scheduler Module 450 may develop a time schedule for on-site field technician testing of a monitored circuit or device into which such a monitored circuit is incorporated. A technician, for example, may be directed (e.g., with a daily schedule and/or in real-time) to service circuitry that has the lowest expected operational time remaining. In such a manner, for example when a technician is between emergency calls for servicing failed equipment, the technician can be directed to service devices that are most likely to fail in the near future. Such servicing may also, for example, include proactively replacing working electrical devices or portions thereof prior to failure with or without performing testing, where the device or portion thereof has been identified as potentially approaching end-of-life. Other factors, such as geography, may also be considered. For example, the Scheduler Module 450 may identify for proactive service the closest equipment and/or equipment within a particular distance of a technician that had been determined to be reaching its end-of life. In such a scenario, between emergency calls, a technician can efficiently visit a nearby site at which an electrical device has been identified as being potentially near its end-of-life. Such operation may also be combined with a manual or automated call service to interact with on-site personnel when scheduling a service visit, in particular an unsolicited service visit.

Other factors such as device age may be a factor in the analysis. For example, as a device reaches a particular age, it might be flagged as nearing end-of-life and/or might be flagged for a higher level of monitoring than newer devices. Also for example, as a device reaches a higher age relative to other devices, other analysis criteria such as thresholds may be adjusted to cause a relatively higher level of scrutiny for the device. For example, a new device operating above a particular threshold might be deemed to be operating normally, while a relatively older device operating above the particular threshold might be considered to be in danger of failing.

Also for example, the Scheduler Module 450 may develop a schedule for component and/or unit ordering. The total and/or local inventory for a device or component may thus be controlled based, at least in part, on the life expectancy of presently fielded devices. For example, if it is determined based at least in part on the above-mentioned determined life expectancy that a particular number of devices are likely to reach end-of-life in a particular geographical region, an order can be proactively placed to ensure that there are ample replacement devices or components thereof available in the region. In an example scenario, the Scheduler Module 450 may determine that N set-top boxes in a county are likely to fail within the next two months, the Scheduler Module 450 may autonomously and/or with manual interaction generate and communicate a purchase and/or shipping order to ensure that the field office servicing the county has an adequate supply of replacement set-top boxes. Such activity may, for example, factor in present inventory levels, shipping delays, etc.

Additionally for example, the Scheduler Module 450 may develop a production schedule for electronic devices or components thereof based, at least in part, on determined life expectancies. Such proactive production scheduling may, for example, serve to reduce the size of inventory stockpiles that are often oversized due to unknown device replacement needs. In an example scenario, it the Scheduler Module 450 determines with a particular degree of likelihood that N number of cable modems will fail in the next calendar year, the Scheduler Module 450 may autonomously and/or with manual interaction generate a production schedule to meet the anticipated need for replacement cable modems (or components thereof). Such activity may, for example, factor in present inventory levels, production lead time, shipping delays, etc.

The Central Monitor/Coordinator 400 may also, for example, comprise one or more Communication Interface modules 412. Such module(s) 412 may, for example, be utilized to communicate circuit information, scheduling information, etc., with other entities over any of a variety of communication networks (e.g., the Internet, a LAN, a WAN, a PAN, etc.). Though such information may be communicated over the same network over which the monitored circuit operation condition information is communicated (e.g., using the Network Interface module(s) 410, such information may be communicated over a separate network as well.

The Central Monitor/Coordinator 400 may also comprise one or more User Interface module(s) 414. Such module(s) 414 may, for example, generate and receive human-perceivable signals for interacting with an operator of the system 400. For example, as explained herein there may be various opportunities for user interaction during the analysis and/or scheduling activities. In such a scenario, the User Interface module(s) 414 may perform the user interface functionality.

The previous discussion presented various characteristics of a system, for example a Central Monitor/Coordinator 400, by way of non-limiting example. The discussion will now move to presenting various functional aspects that may be performed by a system (e.g., a Central Monitor/Coordinator 400) in a flow diagram form.

FIG. 5 shows a flow diagram of an example method 500 for monitoring circuit wear and/or scheduling maintenance related activities, in accordance with various aspects of the present disclosure. The method 500 may, for example, share any or all functional aspects discussed with regard to the system 400 of FIG. 4 and the system 100 of FIG. 1, and discussed previously. The method 500 may, for example, be executed in whole or in part by a central system or computer, for example, the Central Monitor/Coordinator 400 illustrated in FIG. 4 and discussed previously.

The example method 500 may start at step 505. The method 500 may begin executing in response to any of a variety of causes or conditions (e.g., powering up, resetting, receiving logged information from a monitoring circuit, receiving a timer signal, user command, failure detection, receiving a message from a field technician, receiving a message from a sales agent, receiving a message from a production manager, etc.). Accordingly, the scope of various aspects of this disclosure should not be limited by characteristics of any particular cause or condition unless explicitly stated.

The example method 500 may, at step 510, comprise receiving monitored and/or logged operating condition data from a plurality of monitoring circuits. The previous discussions of FIG. 4 (e.g., with regard to the Monitored Data Collector Module 430 and/or Network Interface module(s) 410) and FIG. 1 (e.g., with regard to the Central Monitor/Coordinator 400) presented many non-limiting examples of such receiving. Accordingly step 510 may share any or all characteristics with such previously discussed receiving.

Step 510 may, for example, comprise receiving the logged information (e.g., operating condition information) from the remote monitoring circuit(s) via a communication network interface. Step 510 may comprise receiving the logged information in any of a variety of manners. For example, step 510 may comprise receiving the logged information as one or more respective solicited messages in response to requests sent to the monitoring circuits for the logged information (e.g., at a step not shown in FIG. 5). Also for example, step 510 may comprise receiving the logged information as unsolicited messages from monitoring circuits (e.g., sent autonomously from the monitoring circuits).

In general, step 510 may comprise receiving monitored and/or logged operating condition information from a plurality of monitoring circuits. Accordingly, the scope of various aspects of step 510 should not be limited by characteristics of any particular monitored condition, of any particular type of information, of any particular manner of receiving the information, etc., unless explicitly stated.

The example method 500 may, at step 520, comprise aggregating or collecting the received operating condition data (e.g., as received at step 515). The previous discussions of FIG. 5 (e.g., with regard to the Central Monitor/Coordinator 400 and/or Monitored Data Collector Module 430) and FIG. 1 (e.g., with regard to the Central Monitor/Coordinator 400) presented non-limiting examples of such aggregating or collecting. Accordingly step 520 may share any or all characteristics with such previously discussed aggregating or collecting, for example in a database. In general, step 520 may comprise aggregating or collecting the received operating condition data. Accordingly, the scope of various aspects of step 520 should not be limited by characteristics of any particular type or manner of aggregating, collecting, consolidating, etc.

The example method 500 may, at step 530, comprise analyzing the received and/or aggregated operating condition data to determine life expectancies for the monitored circuits. The previous discussions of FIG. 4 (e.g., with regard to the Central Monitor/Coordinator 400 and/or Data Analysis Module 440) and FIG. 1 (e.g., with regard to the Central Monitor/Coordinator 400) presented many non-limiting examples of such analyzing. Accordingly step 530 may share any or all characteristics with such previously discussed analyzing.

Step 530 may, for example, comprise analyzing the received information (e.g., ad received at step 510 and/or as aggregated at step 520) to ascertain circuit wear and/or to determine a life expectancy (e.g., either absolute or relative to other circuits for maintenance prioritization). Step 530 may, for example, comprise calculating totals of information received for a particular monitored circuit. Such totals may then be utilized to predict life expectancy for a circuit, for example comparing the total to one or more thresholds associated with a circuit nearing end-of-life. In another example scenario, step 530 may comprise tracking peak values for one or more monitored operating conditions. Such peak operating conditions may then be utilized to predict life expectancy for a circuit, for example comparing the peak values to one or more thresholds associated with a circuit nearing end-of-life. In another example scenario, step 530 may comprise averaging received operating condition information. Such averages may then be utilized to predict life expectancy for a circuit, for example comparing the total to one or more thresholds associated with a circuit nearing end-of-life. In yet another example scenario, step 530 may comprise calculating statistical variance and/or standard deviation of received operating condition information. Such information may, for example, be utilized to determine whether a monitored circuit (or device including such circuit) has failed and/or is beginning to fail.

In general, step 530 may comprise analyzing the received and/or aggregated operating condition data to determine life expectancies for the monitored circuits. Accordingly, the scope of various aspects of step 530 should not be limited by characteristics of any particular manner of analyzing nor of any particular information analyzed, unless explicitly stated.

The example method 500 may, at step 540, comprise scheduling maintenance-related activities (e.g., based on the analysis performed at step 530). The previous discussions of FIG. 4 (e.g., with regard to the Central Monitor/Coordinator 400 and/or Scheduler Module 450) and FIG. 1 (e.g., with regard to the Central Monitor/Coordinator 400) presented many non-limiting examples of such scheduling. Accordingly step 540 may share any or all characteristics with such previously discussed analyzing.

Step 540 may, for example, comprise scheduling service activities, scheduling component and/or unit ordering, scheduling shipping activities, scheduling production, etc. In general, step 540 may comprise scheduling maintenance-related activities. Accordingly, the scope of various aspects of step 540 should not be limited by characteristics of any particular schedule nor of any particular manner of scheduling, unless explicitly stated.

The example method 500 may, at step 550, comprise communicating the maintenance-related scheduling (e.g., ad developed at step 540). The previous discussions of FIG. 4 (e.g., with regard to the Central Monitor/Coordinator 400 and/or Scheduler Module 450 and/or the Interface modules 410, 412, and 414) and FIG. 1 (e.g., with regard to the Central Monitor/Coordinator 400) presented non-limiting examples of such communicating.

Accordingly step 550 may share any or all characteristics with such previously discussed analyzing.

Step 550 may, for example, comprise communicating field maintenance scheduling information to a field maintenance organization, a field technician, etc. Also for example, step 550 may comprise communicating inventory distribution scheduling information to a warehouse or other distribution enterprise. Step 550 may further for example comprise communicating scheduled order information to a supplier. Step 550 may additionally for example, comprise communicating production scheduling information to a production enterprise.

In general, step 550 may comprise communicating scheduling information of maintenance-related activities. Accordingly, the scope of various aspects of step 550 should not be limited by characteristics of any particular information communicated nor of any particular manner of communicating such information, unless explicitly stated.

The previous discussion present many example aspects of a system and method for electronic lifetime wear monitoring and/or related scheduling of maintenance-related activity. Various implementations of the system and method may include the utilization of hardware, hardware combined with software, a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the methods described herein.

Various aspects of the present disclosure may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various aspects of the present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While various aspects of the disclosure have been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A system comprising:
a plurality of remote monitoring circuits operable to monitor a plurality of remote monitored circuits, where each of said plurality of remote monitoring circuits is operable to, at least:
monitor operating conditions of a respective one of the plurality of remote monitored circuits;
log data corresponding to the monitored operating conditions; and
communicate the logged data to a central computing device via a communication network; and
a central computing device operable to, at least:
electronically receive, via the communication network, the logged data from the plurality of remote monitoring circuits;
determine respective life expectancies of the plurality of monitored circuits based, at least in part, on the received logged data; and
automatically schedule maintenance-related activities based, at least in part, on the determined respective life expectancies.

2. The system of claim 1, wherein the communication network comprises a hybrid fiber coax (HFC) network, and the remote monitored circuits comprise cable modem circuits.

3. The system of claim 1, wherein the monitored operating conditions comprise power supply characteristics.

4. The system of claim 3, wherein the power supply characteristics comprise amount of current drawn.

5. The system of claim 3, wherein the power supply characteristics comprise amount of power drawn.

6. The system of claim 1, wherein the monitored operating conditions comprise temperature.

7. The system of claim 1, wherein the monitored operating conditions comprise operating time.

8. The system of claim 1, wherein the central computing device is operable to determine respective life expectancies of the plurality of monitored circuit by, at least in part, correlating failures of monitored circuits with the received logged data.

9. The system of claim 1, wherein the scheduled maintenance-related activities comprise a service schedule.

10. The system of claim 1, wherein the scheduled maintenance-related activities comprise a product ordering schedule.

11. The system of claim 1, wherein the central computing device is operable to poll the remote monitoring circuits for the logged data.

12. The system of claim 1, wherein the remote monitoring circuits autonomously determine when to communicate the logged data to the central computing device.

13. A system comprising:
a central computing device operable to, at least:
electronically receive, via a communication network, logged data from a plurality of remote monitoring circuits, where the logged data corresponds to operating conditions experienced by a plurality of monitored circuits;
determine respective life expectancies of the plurality of monitored circuits based, at least in part, on the received logged data; and
automatically schedule maintenance-related activities based, at least in part, on the determined respective life expectancies.

14. The system of claim 13, wherein the monitored operating conditions comprise power supply characteristics.

15. The system of claim 13, wherein the monitored operating conditions comprise temperature.

16. The system of claim 13, wherein the monitored operating conditions comprise operating time.

17. The system of claim 13, wherein the central computing device is operable to determine respective life expectancies of the plurality of monitored circuit by, at least in part, correlating failures of monitored circuits with the received logged data.

18. The system of claim 13, wherein the scheduled maintenance-related activities comprise a service schedule.

19. The system of claim 13, wherein the central computing device is operable to poll the remote monitoring circuits for the logged data.

20. A monitoring circuit operable to, at least:
monitor operating conditions of a respective one of the plurality of remote monitored circuits;
log data corresponding to the monitored operating conditions; and
communicate the logged data to a central computing device via a communication network.

21. The monitoring circuit of claim 20, wherein the monitored operating conditions comprise power supply characteristics.

22. The monitoring circuit of claim 20, wherein the monitored operating conditions comprise temperature.

23. The monitoring circuit of claim 20, wherein the monitored operating conditions comprise operating time.

24. The monitoring circuit of claim 20, wherein the monitoring circuit is operable to determine to communicate the logged data to the central computing device via the communication network in response to a poll signal received from the central computing device.

25. The monitoring circuit of claim 20, wherein the monitoring circuit is operable to autonomously determine to communicate the logged data to the central computing device via the communication network.
